(19) United States
(12) Patent Application Publication
(10) Pub. No.: US 2014/0015785 A1
(43) Pub. Date: Jan. 16, 2014

(54) ELECTRONIC DEVICE

(71) Applicants: Takuya Sato, Osaka-shi (JP); Yasutaka Kaneda, Osaka-shi (JP)

(72) Inventors: Takuya Sato, Osaka-shi (JP); Yasutaka Kaneda, Osaka-shi (JP)

(73) Assignee: KYOCERA CORPORATION, Kyoto-shi, Kyoto (JP)

(21) Appl. No.: 14/007,237

(22) PCT Filed: Mar. 26, 2012
(86) PCT No.: PCT/JP2012/057698

§ 371 Date: Sep. 24, 2013

(30) Foreign Application Priority Data
Mar. 25, 2011 (JP) 2011-067520

(51) Int. Cl. G06F 3/041

(52) U.S. Cl. CPC G06F 3/0412
USPC 345/173

(57) ABSTRACT

An electronic device according to the present invention includes a display screen configured to display information, a touch panel provided on the display screen and configured to be operated by a user, a determination module electrically connected to the touch panel and configured to receive coordinate information from the touch panel by a operation of the user, and a display module configured to display the information on the display screen, wherein when the determination module receives the coordinate information, the displayer displays information of a peripheral area including the coordinates at a position different from the coordinates on the display screen.

### TECHNICAL FIELD

The present invention relates to an electronic device including a plurality of display screens, and a touch panel on at least one of the display screens.

### BACKGROUND ART

There have been known electronic devices including a display screen and touch-panel type operation units provided on a display screen.

In the kind of electronic devices, users can view characters and images displayed on the display screens, as well as perform operating, editing, and the like through tapping, double tapping, flicking, dragging, and the like on such a touch panel.

As a touch-panel type operation unit, resistive-type touch panels and capacitive-type touch panels have predominated, and particularly, in the case where a capacitive-type touch panel is used, a user needs to perform operations with a finger tip.

When the user operates information displayed on the display screen by directly touching the touch panel with a finger tip, it is difficult to perform a precise touch motion, because a touch point, which is a contact point between the finger tip and the touch panel, hides behind the finger tip.

Particularly, when various operations, for example, operations of drawing, editing of music and moving images, games and the like are performed through the touch panel, accurate operations cannot be performed if the touch point cannot be viewed.

Thus, there has been a need for electronic devices that enable maneuverability to be improved as much as possible by displaying a touch point hiding behind a finger tip in another area when a touch panel is operated.

### SUMMARY OF THE INVENTION

An electronic device according to an aspect of the present invention includes:

a display screen configured to display information;

a touch panel provided on the display screen and configured to be operated by a user;

a determination module electrically connected to the touch panel and configured to receive coordinate information from the touch panel by a operation of the user; and

a display module configured to display the information on the display screen,

wherein when the determination module receives the coordinate information, the display module displays information of a peripheral area including the coordinates at a position different from the coordinates on the display screen.

### BRIEF DESCRIPTION OF THE DRAWINGS

FIG. 1 is a perspective view of an electronic device according to an embodiment of the present invention.

FIG. 2 is a block diagram of the electronic device according to an embodiment of the present invention.

FIG. 3 is a flow chart diagram illustrating operations according to an embodiment of the present invention.

FIG. 4 is an explanation view illustrating an example of display of the electronic device according to an embodiment of the present invention.

FIG. 5 is an explanation view of an example of display of the electronic device according to an embodiment of the present invention.

FIG. 6 is an explanation view illustrating an example of different display of the electronic device according to an embodiment of the present invention.

FIG. 7 is an explanation view illustrating an example of further different display of the electronic device according to an embodiment of the present invention.

FIG. 8 is an explanation view illustrating an example of display when the number of the display screen is one in the electronic device according to an embodiment of the present invention.

FIG. 9 is an explanation view illustrating one example of display on another display screen in the electronic device according to an embodiment of the present invention.

FIGS. 10(a) to 10(e) are explanation views illustrating one example of transition of display when an icon is moved across the two display screens in the electronic device according to an embodiment of the present invention.

### DETAILED DESCRIPTION OF EMBODIMENTS

An embodiment of the present invention relates to an electronic device 10 that includes at least one of display screens 21 and 31, on at least one of which touch panels 22 and 32 are provided. The electronic device 10 is adapted to activate one or more applications. Under such circumstances in the electronic device 10, when information such as characters, graphics, images, pictures and moving images is displayed on the display screens 21 and 31, a user can perform editing and the like on such information by operating the touch panel 22 and/or the touch panel 32.

More specifically, the embodiment of the present invention relates to the electronic device 10 that solves the problem that the displayed information hides behind a finger tip F of the user, or the like, thereby disabling precise operations, when the information displayed on the display screens 21 and 31 is operated on the touch panels 22 and 32.

Hereinafter, there will be described an electronic device 10 according to an embodiment of the present invention, by exemplifying a portable-type electronic device, with reference to the drawings. However, the configuration and the structure of the electronic device which will be described in detail later are merely for illustrative purposes, and the present invention should not be restrictively understood, as a matter of course.

First, there will be described a structure of the portable-type electronic device 10 according to the present embodiment.

The electronic device 10 includes display units 20 and 30, as illustrated in FIG. 1. The display units 20 and 30 include two display screens 21 and 31 capable of displaying thereon, information such as characters, graphics, images, pictures, and moving images, in association with applications desired by the user, and the touch panels 22 and 32 that the user can operate by touching surfaces of the display screens. The display units 20 and 30 are coupled to each other through a coupling mechanism 40, such that they can be moved with respect to each other by opening and closing, sliding and the like. The number of the display units 20 and 30 is not limited to two, but may be one or can be three or more.

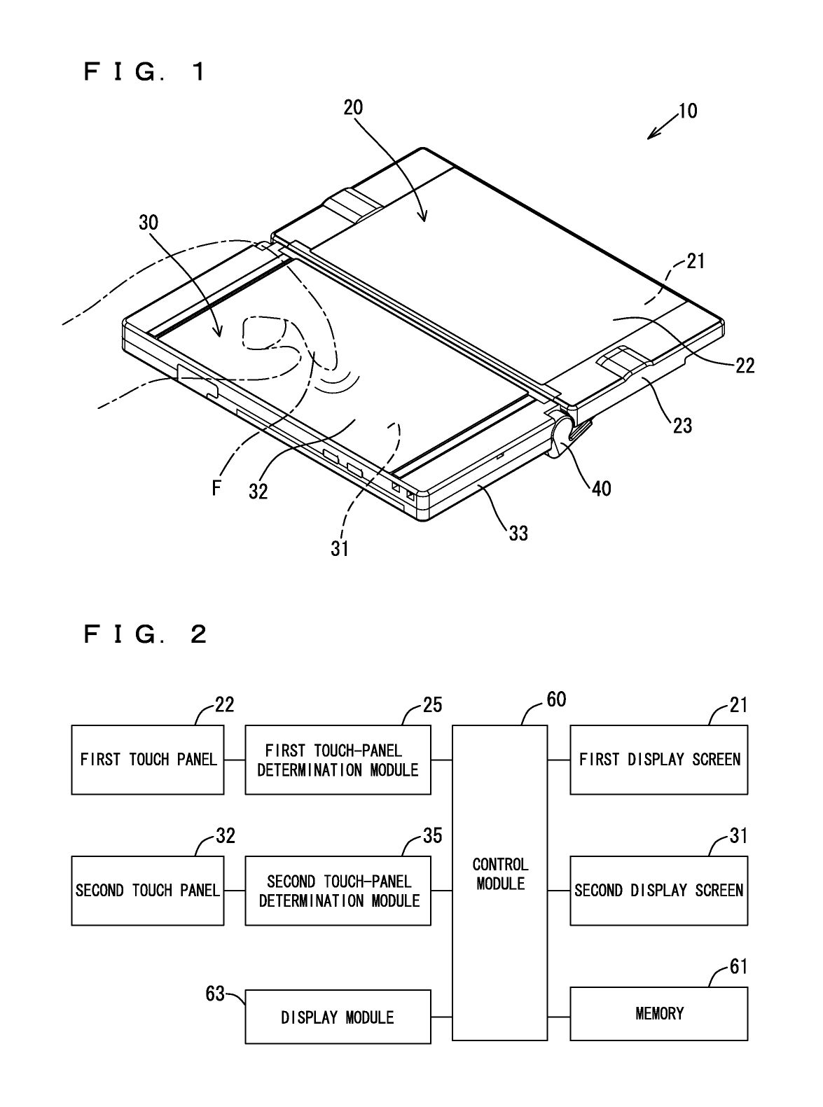

The first display unit 20 and the second display unit 30 are housed within casings 23 and 33 which are opened at their respective surfaces in one side, such that the display screens 21 and 31 capable of displaying information thereon can be viewed from the opened sides, as illustrated in FIG. 1. The display screens 21 and 31 are electrically connected to a control module 60 (see FIG. 2), which will be described later, and can display various types of information thereon. Further, referring to FIG. 1, the display unit positioned in the right back side in the paper plane is referred to as the first display unit 20, while the display unit positioned in the left front side is referred to as the second display unit 30.

The display screens 21 and 31 are constituted by liquid crystal displays, for example. The display units 20 and 30 include the touch panels 22 and 32 that the user can operate by touching them with a finger tip F or the like, on the respective opening-sides of the display screens 21 and 31. The touch panels 22 and 32 are made transparent in order to enable the display screens 21 and 31 to be viewed therethrough and are provided in such a way as to close the openings of the casings 23 and 33. As a type of the touch panels 22 and 32, it is possible to exemplify a capacitive-type or a resistive-type.

The touch panels 22 and 32 are electrically connected to the control module 60 through touch-panel determination modules 25 and 35, as shown in FIG. 2. The user operates the touch panels 22 and 32 with the finger tip F or the like, by which relevant coordinate information is inputted to the control module 60 through the touch-panel determination modules 25 and 35 to be used for various operations and the like.

The first display unit 20 and the second display unit 30 can be made movable with respect to each other through the coupling mechanism 40. Although a structure of the coupling mechanism 40 is not described in detail, this structure can be such that the first display unit 20 is made slidable and/or rotatable with respect to the second display unit 30, for example.

FIG. 2 illustrates a block diagram of the electronic device according to an embodiment of the present invention.

The electric device is overall controlled by the control module 60 constituted by a CPU or the like, as illustrated in FIG. 2.

The above-described first display screen 21 and the second display screen 31 are electrically connected to the control module 60. Moreover, a display module 63 connected to the control module 60 enables the first display screen 21 and the second display screen 31 to display various types of information according to application software used therein.

Moreover, the first touch panel 22 and the second touch panel 32 are electrically connected to the control module 60 through the first touch-panel determination module 25 and the second touch-panel determination module 35. Inputs of the user from the first touch panel 22 and the second touch panel 32 are transmitted to the control module 60 through the touch-panel determination modules 25 and 35 as the coordinate information. The control module 60 performs the editing, the operating and the like of the information of the display screens 21 and 31 in accordance with the inputs.

Furthermore, the display module 63 extracts information of a peripheral area of the coordinates to display in the vicinity of the coordinates, based on the coordinate information acquired by the touch-panel determination modules 25 and 35.

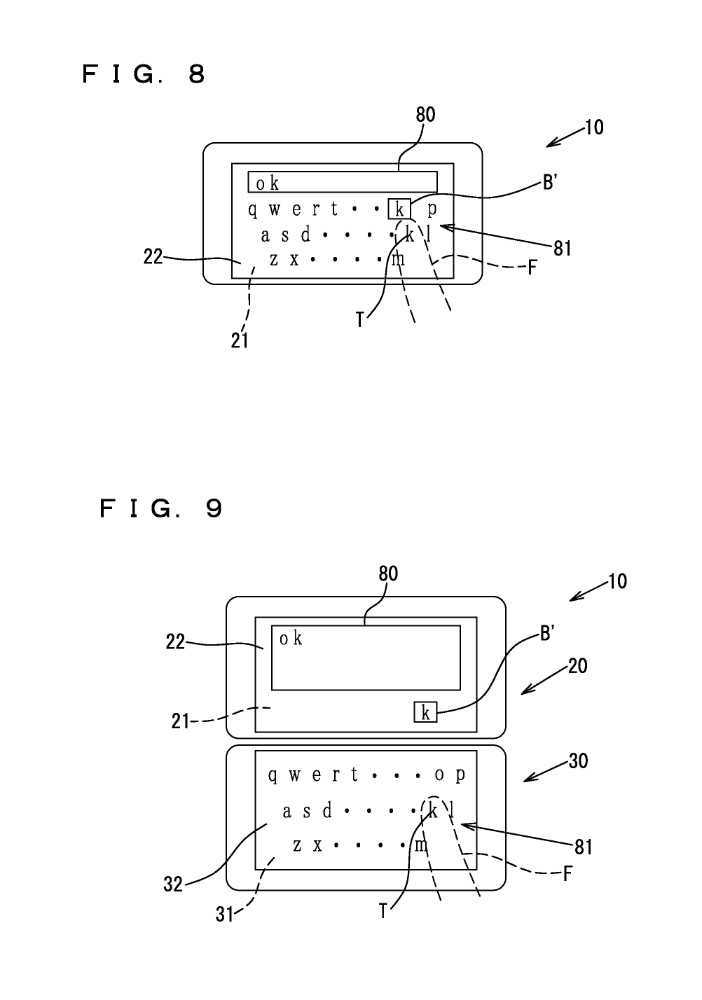

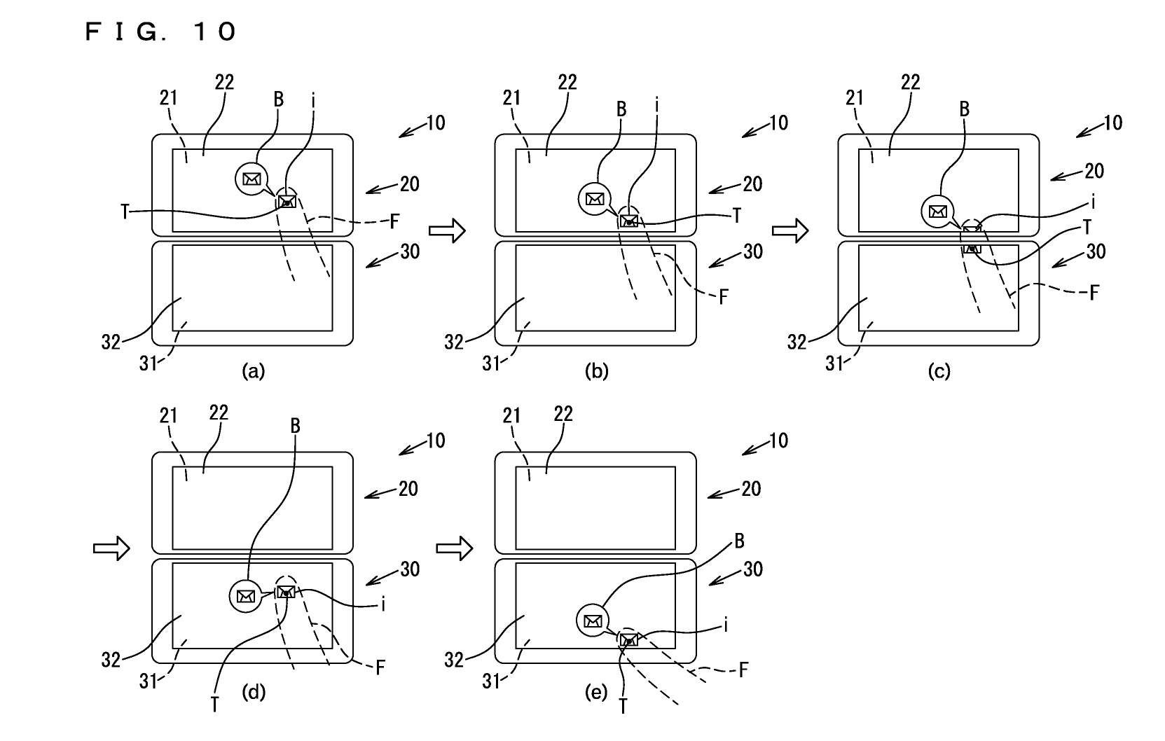

Although the display module 63 enlarges and displays the information of the peripheral area of the coordinates in order to enhance visibility (see FIGS. 5 to 7), same-magnification display (see FIGS. 8 and 10) or reduced display may be employed. Furthermore, in the case where the electronic device 10 has the plurality of display screens 21 and 31, the information of the peripheral area of the coordinates may be displayed on the display screen (e.g., 21) different from the touch panel (e.g., 32) relating to the operation of the user (see FIG. 9).

In addition thereto, a memory 61 for storing various types of operations of the electronic device 10, various types of data desired by the user, and the like, are electrically connected to the control module 60.

The control module 60 can apply an operating system, so that one application can be activated or a plurality of applications can be simultaneously activated. Information relating to the application can be displayed continuously on the first display screen 21 and on the second display screen 31, or information relating to the different applications can be displayed thereon, respectively. Moreover, on a home screen, which is a screen of the operating system, icons and the like are displayed on the first display screen 21 and/or the second display screen 31.

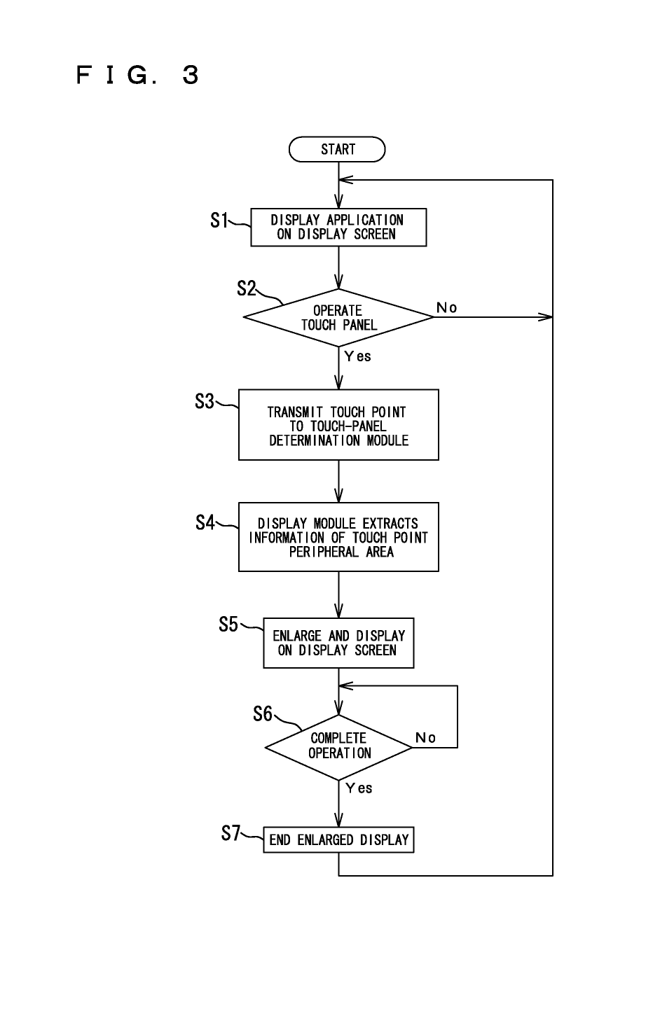

Operating the first touch panel 22 and/or the second touch panel 32 enables the editing and the like of the information to be performed. More specifically, it can be considered that the information of the application such as a browser is displayed on the first display screen 21, while the information of the application such as drawing software is displayed on the second display screen 31, and that a operation of the second touch panel 32 allows drawing/editing and the like as shown in FIG. 3 to be performed.

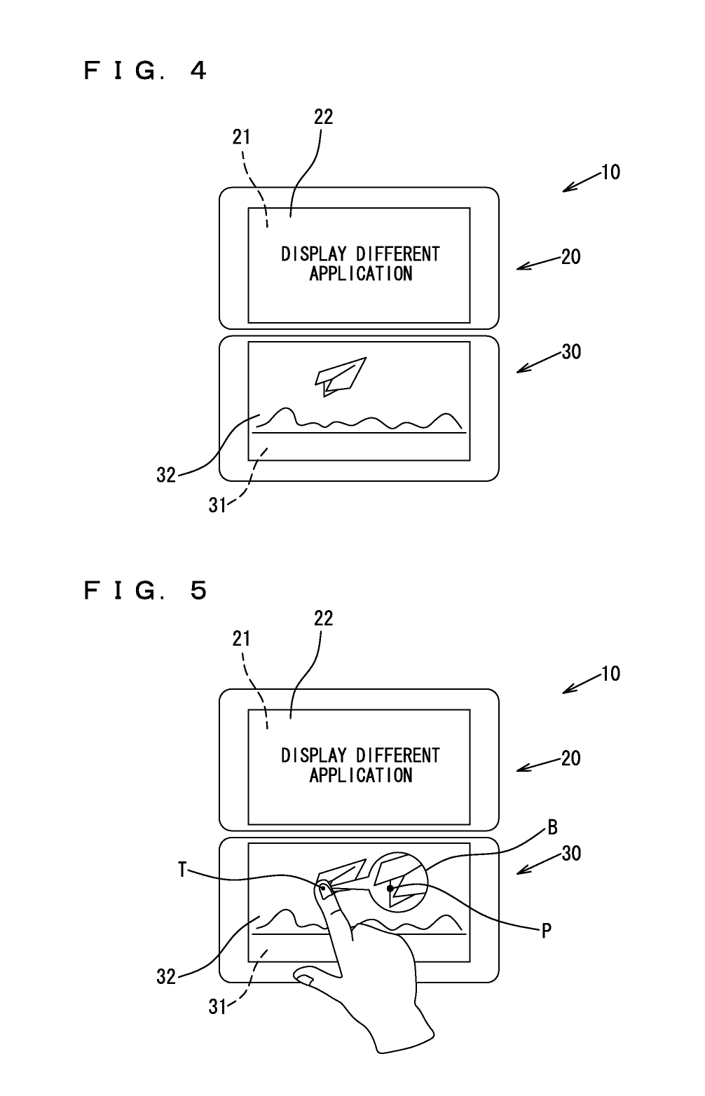

In this manner, when the display module 63 displays the information on the first display screen 21 and the second display screen 31 (see step 1 in FIG. 3, and FIG. 4), and the user operates the first touch panel 22 and/or the second touch panel 32 (step 2), a touch point (the coordinate information) of the operated touch panel (hereinafter, the second touch panel 32) is transmitted to the touch-panel determination module (the touch-panel determination module 35) (step 3). At this time, the display module 63 extracts the information of the peripheral area of the touch point (the coordinate information) that the touch-panel determination module 35 has received (step 4), and enlarges and displays the information of the peripheral area of the touch point at a position different from the touch point of the relevant display screen, that is, the second display screen 31 (step 5).

The display of the peripheral area of the touch point can be performed inside a balloon B drawn out from a touch point T, as shown in FIG. 5. A pointer P indicating the touch point T is displayed in the balloon B at the same time, which enables the user to visually recognize that it is enlarged display of the peripheral area of the touch point T.

When the user performs desired operations, referring to FIG. 5, and ends the operations (step 6), the enlarged display by the display module 63 ends (step 7).

When the user performs a operation such as so-called flicking, which is a operation of touching the touch panels 22 and 32 with a finger, a stylus or the like, and then rapidly sweeping the finger, and so-called dragging, which is a operation of moving the touch point T while keeping touching the touch panels 22 and 32, it is desirable that the display by the balloon B of the peripheral area is also moved in accordance with a locus thereof.

Normally, when the user operates the second touch panel 32 with the finger tip F, the information of the second display screen 31 hides behind the finger tip F or the like, which disables the user to view the touch point T. However, in the present embodiment, since the information of the second display screen 31 relating to the touch point T of the user is enlarged and displayed inside the second display screen 31 together with the pointer P, the user can check the information selected or the like through the second touch panel 32 by referring to the balloon B, and can perform the desired precise operation.

As the enlarged and displayed peripheral area of the touch point T, a circular or rectangular area of about 1 to 2 cm, which is considered to hide behind the finger F of the user, can be exemplified. Moreover, a magnification factor of the information displayed in the balloon B is preferably about 1 to 3 times.

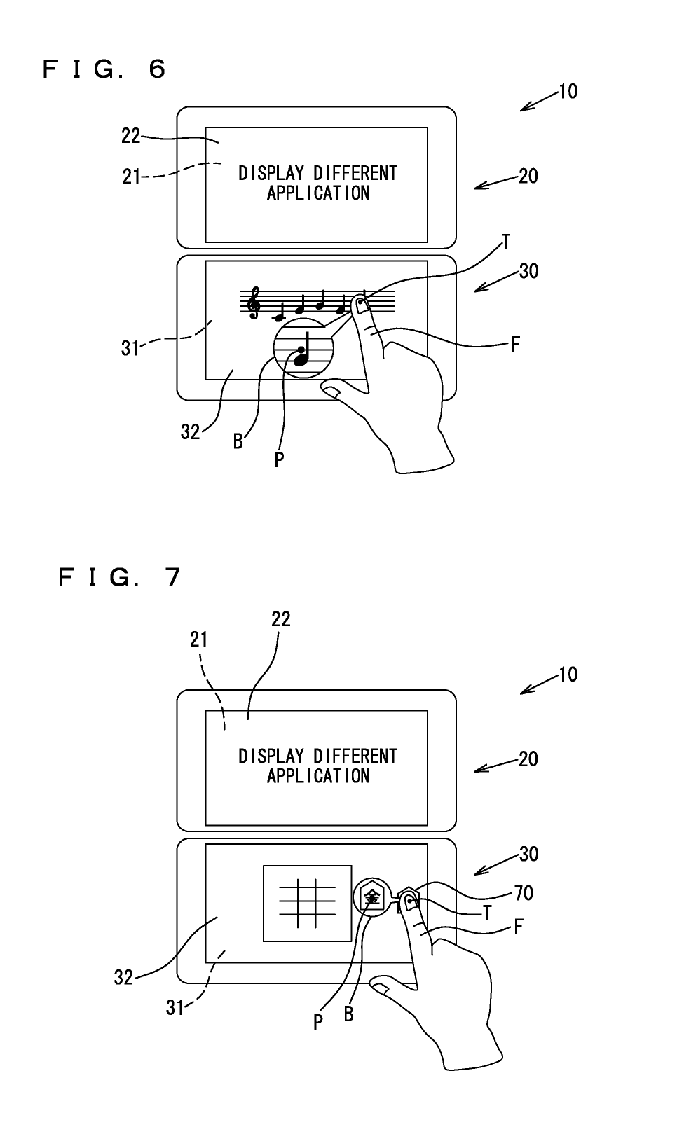

While it is desirable in view of maneuverability and visibility that an area where the balloon B is displayed is an upper right area of the touch point T, in some sites of the display screen that the user touches, obviously, it is also possible to set the area where the balloon B is displayed to be a lower left area, a left area or the like, as shown in FIGS. 6 and 7. At this time, as shown in FIG. 6, the balloon B is desirably displayed so as to avoid overlapping graphics or the like displayed by the application.

As application software whose maneuverability is assumed to be improved as much as possible by the present embodiment, in addition to the foregoing, photo-retouching software, moving-image editing software, composition sequencer software (see FIG. 6), game software (see FIG. 7) and the like can be exemplified.

While in the above-described embodiment, in order to enhance the visibility and the maneuverability of the information of the touch point T, the information of the periphery of the touch point T is enlarged and displayed, obviously, it is also possible to display the information at the same magnification or to reduce and display the information in place of the enlarged display. Moreover, as described below, various modifications can be made to the present invention.

FIGS. 8 and 9 show embodiments in each of which an application for creating documents, such as mail software, is activated.

FIG. 8 shows the embodiment of one-screen display in which the second display screen 31 is slid and rotated in a downward direction of the first display screen 21 to be made invisible. On the visible first display screen 21, a text frame 80 is displayed on an upper side thereof, and a soft keyboard 81 is displayed on a lower side thereof.

The display module 63 is adapted to display a pressed key “k” with a frame enclosure B′, when in FIG. 8, the user presses any key (in the illustration, “k”) on the soft keyboard 81 with the finger F. This enables the user to visually check the key that he or she has pressed, which prevents a typing error and the like, thereby improving the maneuverability.

FIG. 9 is the embodiment in which the text frame 80 is displayed on the first display screen 21, and the soft keyboard 81 is displayed on the second display screen 31. The display module 63 is adapted to display the pressed key “k” with the frame enclosure B′ on the first display screen 21, when the user presses any key (in the illustration, “k”) on the soft keyboard 81 with the finger F. This enables the user to visually check the key that he or she has pressed, which prevents a typing error and the like, thereby improving the maneuverability.

While in FIG. 8, the frame enclosure B′ is overlapped on the soft keyboard 81 because of limitation of a size of the display screen, in the embodiment of FIG. 9, the frame enclosure B′ is displayed on the first display screen 21, which can prevent the above-described overlap, and further, can improve the visibility and the maneuverability.

FIG. 10 shows transition of a display state where the information (in the illustration, a mail icon i) is moved across the plurality of display screens 21 and 31. When as shown in FIG. 10A, on the home screen, for example, the icon i on the first display screen 21 is dragged downward with the finger F, as shown in FIG. 10B, the icon i hiding behind the finger F is displayed in the balloon B in a manner similar to the foregoing.

When in this state, as shown in FIGS. 10(b) to 10(d), a drag motion is performed so as to straddle from the first display screen 21 to the second display screen 31, that is, from the first touch panel 22 to the second touch panel 32, the display module 63 moves the display of the balloon B from the first display screen 21 to the second display screen 31 in accordance with a position of the finger F. Since this enables the display of the balloon B to be performed at a position near the icon i that the user is touching, the visibility and the maneuverability can be enhanced.

When the balloon B is moved from the first touch panel 22 to the second touch panel 32, the display module 63 moves the display of the balloon B so as to avoid a border portion between the display screens 21 and 31 as shown in FIGS. 10(a) to 10(e), which can make it easy to view the balloon B.

The balloon B moved to the second display screen 31 may be displayed on the second display screen 31, as shown in FIG. 10(e), if the finger F is placed on the second touch panel 32.

Even if there is a distance between the first touch panel 22 and the second touch panel 32, when the operation is performed with a finger 90, an area where the finger 90 comes into contact with the touch panels 22 and 32 is relatively large, and thus, the drag motion straddling from the first touch panel 22 to the second touch panel 32 can be recognized as a continuous drag motion. However, in the case where the distance between the touch panels 22 and 32 is large, or when the touch panels 22 and 32 are operated with a stylus or the like, a signal of the drag motion may be interrupted between the touch panels 22 and 32. In the above-described case, if the second touch-panel determination module 35 receives the signal of the drag motion within a predetermined time after the first touch-panel determination module 25 has received the signal of the drag motion, it may be determined to be a continuous drag motion.

The present embodiment is effective as an electronic device that can display a touch point hiding behind a finger when a touch panel is operated, and can enhance the maneuverability.

### DESCRIPTION OF REFERENCE CHARACTERS

10 electronic device
20 first display unit
21 first display screen
22 first touch panel
25 first touch-panel determination module
30 second display unit
31 second display screen
32 second touch panel
35 second touch-panel determination module
40 coupling mechanism
60 control module
63 display module
B balloon
P pointer
F finger tip
T touch point

1. An electronic device comprising:
a display screen configured to display information;
a touch panel provided on the display screen and configured to be operated by a user;
a determination module electrically connected to the touch panel and configured to receive coordinate information from the touch panel by a operation of the user; and
a display module configured to display the information on the display screen,
wherein when the determination module receives the coordinate information, the display module displays information of a peripheral area including the coordinates at a position different from the coordinates on the display screen.

2. The electronic device according to claim 1, wherein the display module enlarges and displays the information of the peripheral area including the coordinates.

3. The electronic device according to claim 1, wherein the display module displays the information of the peripheral area including the coordinates so as to avoid different information displayed on the display screen.

4. The electronic device according to claim 1, wherein a plurality of display screens are arranged, each of which is identical to the display screen, and the display module displays the information of the peripheral area including the coordinates on the display screen different from the touch panel operated by the user.

5. The electronic device according to claim 1, wherein the touch panel is of a capacitive type.

6. A control method of an electronic device comprising:
a display screen configured to display information;
a touch panel provided on the display screen and configured to be operated by a user;
a determination module electrically connected to the touch panel and configured to receive coordinate information from the touch panel by a operation of the user; and
a display module electrically connected to the display screen and the determination module, and configured to display the information on the display screen,
wherein when the information is displayed on the display screen, and the determination module receives the coordinate information, the display module displays information of a peripheral area including the coordinates at a position different from the coordinates on the display screen.
